(19) United States
(12) Patent Application Publication
(10) Pub. No.: US 2010/0220487 A1
(43) Pub. Date: Sep. 2, 2010

(54) LIGHTING ASSEMBLY AND HEAT EXCHANGE APPARATUS FOR UNIFORM HEAT DISSIPATION

(75) Inventors: Lu Ming, New Territories (TW); Wu Kai Chiu, New Territories (HK)

Correspondence Address: BROOKS KUSHMAN P.C., 1000 TOWN CENTER, TWENTY-SECOND FLOOR, SOUTHFIELD, MI, 48075, US

(73) Assignee: HONG KONG APPLIED SCIENCE AND TECHNOLOGY RESEARCH INSTITUTE CO. LTD., New Territories (HK)

(21) Appl. No.: 12/394,648

(22) Filed: Feb. 27, 2009

(51) Int. Cl. F21V 29/00

(52) U.S. Cl. 362/373

(57) ABSTRACT

A heat exchange apparatus and lighting apparatus for uniform heat dissipation are provided. According to one embodiment of the invention, one or more dissipation plates are provided, each of the one or more dissipation plates having a plurality of upstanding fins disposed from the dissipation plate at a predetermined angle, and each of the one or more dissipation plates defines a plurality of slots configured to permit airflow longitudinally through the housing. A housing is provided to receive the one or more dissipation plates, the housing defining at least one opening to permit an inlet of air into the housing. The configuration of the dissipation plates and the housing permit air to move within the housing in a plurality of directions, permitting heat to be dissipated when the housing is positioned in different orientations. Improved heat dissipation thereby results in greater consistency in the performance of the lighting apparatus.

### FIELD OF THE INVENTION

The present invention relates to a lighting assembly, and more particularly, to a lighting assembly for uniform heat dissipation in lighting devices.

### BACKGROUND OF THE INVENTION

Light emitting diode (LED) technology is currently one of the most innovative and fastest growing in the lighting industry. While LED have been in use for decades for indicator and signaling purposes, technology developments and improvements have allowed for a broader use. The use of LED in lighting applications has grown especially rapidly in recent years.

The use of LED in lighting applications is attractive for a number of reasons, including the ability to provide higher levels of illumination, a longer life cycle, minimum maintenance requirements, energy efficient, and flexibility in terms of coloring and beam control.

LED generates a generally high level of heat during operation. It is also known that changes in the temperature of the p-n junction of an LED (“the junction temperature”) can affect the performance of the LED, especially in color applications. This can be especially problematic when an LED lighting device is used in different orientations, since some orientations result in operation of the LED at higher temperatures. Efforts to control the temperature of LED have been made. However, previous efforts have failed to address certain applications or configurations. Accordingly, there is a need for a lighting assembly and a heat exchange apparatus that addresses these and other shortcomings of LED lighting.

### SUMMARY OF THE INVENTION

According to one embodiment of the present invention, a heat exchange apparatus is disclosed. The heat exchange apparatus includes one or more dissipation plates, each of the one or more dissipation plates having a plurality of upstanding fins disposed from the dissipation plate at a predetermined angle, and wherein each of the one or more dissipation plates defines a plurality of slots configured to permit airflow longitudinally through the housing; and a housing configured to receive the one or more dissipation plates, the housing defining at least one opening to permit an inlet of air into the housing.

According to another embodiment of the present invention, a lighting assembly is disclosed. The lighting assembly includes a housing having at least one opening to permit the inlet of air into the housing; one or more dissipation plates positioned within the housing, each of the plurality of dissipation plates having a plurality of fins disposed from each of the plurality of dissipation plates at a predetermined angle, one or more dissipation plates axially aligned within the housing; a substrate positioned within the housing; and one or more light emitting device bonded on the substrate, wherein the substrate provides an electrical connection for receiving power and transmitting power to the one or more light emitting devices.

According to another embodiment of the present invention, a lighting assembly is disclosed. The lighting assembly includes a housing having at least one opening to permit the inlet of air into the housing; light emitting means for generating light, the light emitting means positioned within the housing; dissipation means for dissipating heat caused by the light emitting means during operation of the lighting assembly, the dissipation means positioned within the housing, the dissipation means includes a first plurality of surfaces lying in a lateral plane and a second plurality of surface lying in one or more longitudinal planes, and where the dissipation means defines openings for the passage of air within the housing in both the lateral and the longitudinal directions; and connection means for providing current to the light emitting means.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a front perspective view of a lighting assembly 100, in accordance with an embodiment of the present invention.

FIG. 2 is a rear perspective view of the lighting assembly shown in FIG. 1, in accordance with an embodiment of the present invention.

FIG. 3 is a side view of the lighting assembly shown in FIG. 1, in accordance with an embodiment of the present invention.

FIG. 4 is a side cross sectional view of the lighting assembly shown in FIG. 1, in accordance with an embodiment of the present invention.

FIG. 5 is an exploded view of the lighting assembly shown in FIG. 1, in accordance with an embodiment of the present invention.

FIG. 6 is a perspective view of the dissipation plates, in accordance with an embodiment of the present invention.

FIG. 7 is a side cross sectional view of a lighting assembly, in accordance with a second embodiment of the present invention.

FIG. 8 is an exploded view of the lighting assembly shown in FIG. 7, in accordance with an embodiment of the present invention.

FIG. 9 is a side cross sectional view of a lighting assembly, in accordance with a third embodiment of the present invention.

FIG. 10 is an exploded view of the lighting assembly shown in FIG. 9, in accordance with an embodiment of the present invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive.

Generally, embodiments of the present invention are directed to a lighting assembly that provides for temperature management and uniform heat dissipation in a plurality of different orientations. In one embodiment, the flow of air in and through the lighting assembly and dissipation of heat from the lighting assembly into the air is permitted at generally the same rate, regardless of the orientation of the lighting assembly. Therefore, a generally consistent convective heat transfer rate can be achieved while the lighting assembly is positioned at different orientations. Accordingly, embodiments of the present invention ensure that the average temperature of the lighting assembly, and therefore the LED junction temperature, is generally maintained at a consistent level, or within a predetermined range, so that the heat dissipation of the lighting assembly is generally uniform regardless of the positioning of the lighting assembly, and the overall performance of the LED may be generally more consistent.

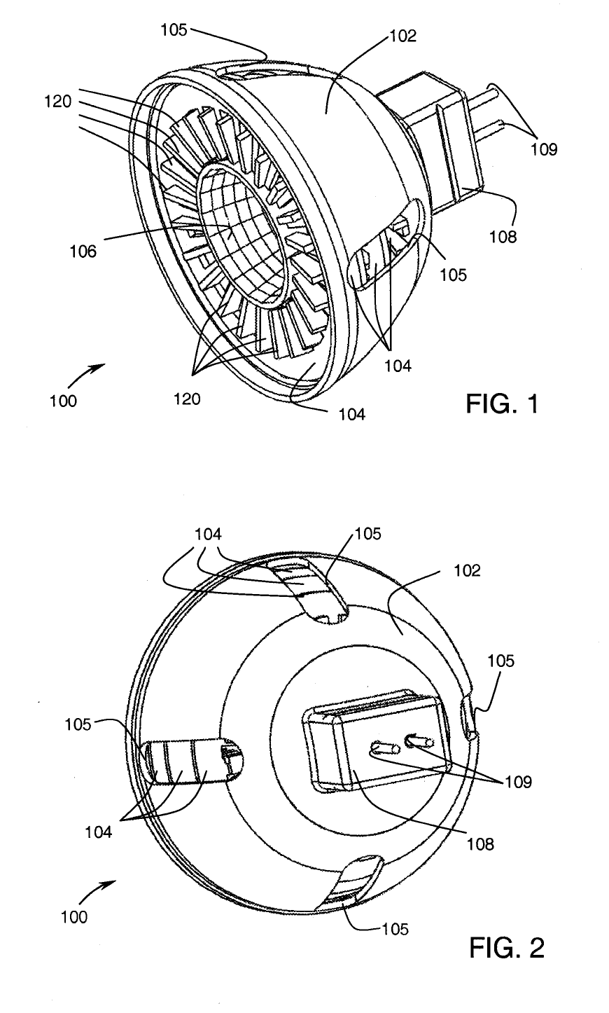

Referring now to the figures, FIG. 1 is a front perspective view of a lighting assembly, in accordance with an embodiment of the present invention. The lighting assembly 100 includes a housing 102, a plurality of dissipation plates 104, optics 106, a fitting 108, and an electrical connector 109. The lighting assembly 100 also includes a light emitting diode (“LED”) 110 (shown in FIG. 5) and an LED substrate 112 (shown in FIG. 5). The housing 102 may include one or more openings 105 defined in the housing 102 to permit the inlet of air into the lighting assembly 100. Each of the dissipation plates 104 (partially shown) includes a plurality of fins 120.

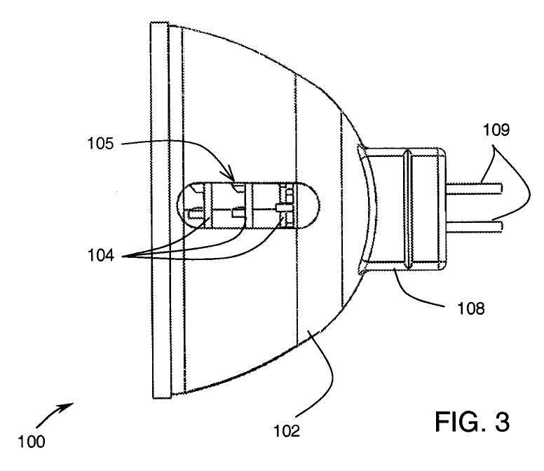

FIG. 2 is a rear perspective view of the lighting assembly shown in FIG. 1, and FIG. 3 is a side view of the lighting assembly shown in FIG. 1, in accordance with an embodiment of the present invention. The housing 102, the plurality of dissipation plates 104, the one or more openings 105, the fitting 108, and the electrical connector 109 may be seen. In FIGS. 2 and 3, the plurality of dissipation plates 104 may be seen through the one or more openings 105 in the housing 102.

The one or more openings 105 may be any suitable size depending on the size and configuration of the housing 102. However, the one or more openings 105 should be of a sufficient size to act as an inlet for air to pass into the housing. For example, one suitable opening may have a diameter of between approximately two (2) and three (3) millimeters. However, smaller or larger openings may be used. Also, while one opening may be sufficient, a plurality of openings is used to increase the airflow into the housing 102. There is also a relationship between the number and size of the openings. For example, a greater number of smaller openings may be used to achieve performance similar to that of a fewer number of larger openings. Accordingly, embodiments of the present invention are not limited to the opening configuration illustrated in the figures. The one or more openings 105 may also be of any suitable shape, such as round or elongated, as illustrated in the example embodiments. The lamp housing may be made from any suitable materials and may be made using any suitable production methods such as, for example, metal drawing, metal punching, die-casting, or sintering.

The lighting assembly may generally be separated into a lighting module, a heat dissipation module, and an electrical module. According to one embodiment, the lighting module includes the optics 106, the LED 110, and the substrate, the heat dissipation module includes at least one of the dissipation plates 104 and the housing 102, and the electrical module includes the electrical connector 109 and any connection for powering the lighting apparatus. Each of the modules may include either greater or fewer components. However, a discrete identification of separate modules is provided for illustration purposes.

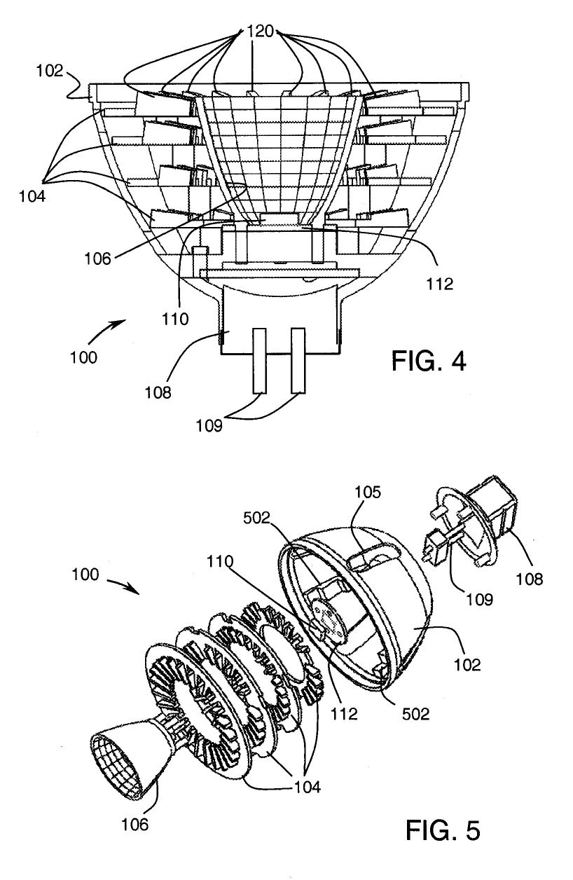

Referring now to FIGS. 4 and 5, FIG. 4 is a side cross sectional view of the lighting assembly shown in FIG. 1, and FIG. 5 is an exploded view of the lighting assembly shown in FIG. 1, in accordance with an embodiment of the present invention. In FIGS. 4 and 5, the housing 102, a plurality of dissipation plates 104, the optics 106, the fitting 108, the electrical connector 109, the LED 110, and the LED substrate 112 one shown. The plurality of fins 120 on each of the plurality of dissipation plates 104 are also shown.

The order and position of the different components of the lighting assembly 100 can be seen in FIGS. 4 and 5. The LED 110 and the substrate 112 are positioned within the housing proximate to the fitting end of the housing 102. The plurality of dissipation plates 104 are positioned within the housing 102 generally axially aligned so that the optics 106 may be positioned at the longitudinal center of the housing 102 through central openings of each of the dissipation plates, if the optics is included in the embodiment. The plurality of dissipation plates 104 are generally parallel to each other and are spaced apart from each other a predetermined distance. The spacing of the dissipation plates 104 may be achieved by stepped supports 502 (shown in FIG. 5) on the inner side of the housing. Any suitable number of stepped supports 502 may be included. The spacing permits and facilitates airflow within the housing 102 and between the dissipation plates 104.

Any suitable fitting 108 and electrical connector 109 may be used to provide power to the substrate 112 and the LED 110. One example fitting 108 and electrical connector 109 are included and described for the purpose of illustration. However, any suitable configuration of the fitting 108 and the electrical connector 109 may be used depending on the device or lighting system that will receive the lighting assembly 100.

Variation of temperature in the lighting assembly 100, and therefore the junction temperature of the light emitting diode 110 or LED chip package being used in the lighting assembly, is directly related to airflow and the surface area of heat dissipation components of the lighting assembly 100.

Where the power provided to the lighting assembly is generally constant, Newton's law of cooling holds that: Q=hA(Tᵢ−T_{amb}), where

Q=heat transfer rate;

h=airflow constant;

A=surface area of the dissipation plate, or other heat dissipation components;

Tᵢ=the junction temperature; and

T_{amb}=the ambient temperature.

Therefore, temperature variation has direct relationship with the airflow constant h and the surface area for heat dissipation A. In conventional lighting, the airflow constant can change substantially depending on the orientation of the lighting assembly. For example, a downward oriented lighting assembly generally results in substantially reduced airflow. Embodiments of the present invention, however, reduce the variation of the airflow constant as the lighting assembly is positioned in different orientations, thereby reducing variation of the temperature of the lighting assembly 100 positioned in different orientations. Regardless of the orientation of the lighting assembly, one or more features of the present invention operate together to reduce the air flow resistance of the lighting assembly 100 and reduce the variation in the airflow constant. Accordingly, the air flow resistance stays generally constant during operation of the lighting apparatus in multiple orientations.

According to Newton's law of cooling, the junction temperature of an LED may be reduced by either increasing the surface area of the object in contact with the air or increasing the airflow constant. According the embodiments of the present invention, airflow within the housing 102 is increased by the positioning and configuration of the dissipation plates. The spacing of the dissipation plates permits increased airflow laterally between the dissipation plates, and a plurality slots permit increased airflow longitudinally thought the dissipation plates and within the housing 102.

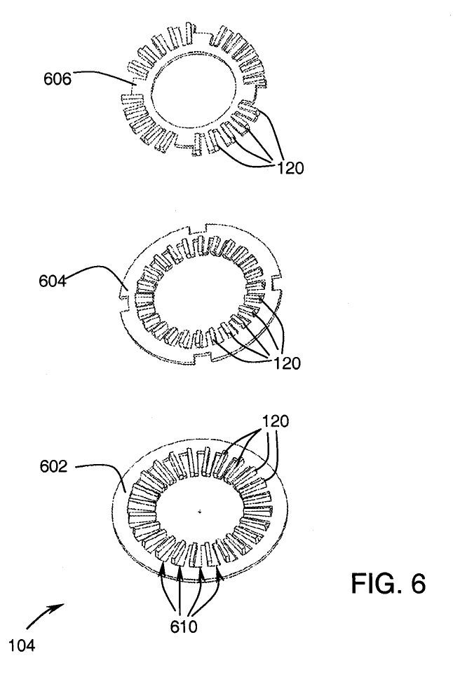

Referring now to FIG. 6, a perspective view of the dissipation plates is shown, in accordance with an embodiment of the present invention. A first dissipation plate 602, a second dissipation plate 604, and a third dissipation plate 606 are shown for the purposes of illustration. Each of the dissipation plates 104 are generally ring shaped, defining an opening in the axial center of each of the dissipation plates. The openings are configured to permit airflow longitudinally through the dissipation plates 104 and through the housing 102 when included in the lighting assembly 100. In some embodiments, the openings permit light from the LED 110 to pass through the dissipation plates 104. Each of the dissipation plates 104 includes a plurality of upstanding fins 120 formed contiguously with the lateral surfaces of the dissipation plate 104. However, fins may be formed on the dissipation plates using any suitable method.

The dissipation plates 104 may be made from any suitable material that dissipates heat, such as metal or ceramic materials. For example, the dissipation plates 104 may be made from aluminum or copper. The dissipation plates may be made according to any suitable method such as, for example, mechanical punching, die-casting, or sintering. According to one embodiment of the present invention, each of the dissipation plates 104 is punched from a generally flat disk of metal material. Referring to the numbering shown with reference to the first dissipation plate 602, during punching, portions of the disk are bent to protrude away from the disk at an angle, the bent portions creating a plurality of slots 610. The bent portions form the fins 120 of the dissipation plate 104. Dissipation plates 104 made according to this method result in a dissipation plate 104 that has approximately the same surface area as the flat disk, therefore requiring no additional material than a flat dissipation plate. However, the configuration of the dissipation plate permits increased airflow through the slots 610 of the dissipation plate and also permits heat transfer in the lateral direction, generally parallel to the dissipation plate, and in the longitudinal direction, generally parallel to the axis of the dissipation plate, along the surface of the fins 120. While illustrated with reference to the first dissipation plate 602, the other illustrated dissipation plates 104 have a similar configuration.

Each of the plurality of dissipation plates 104 may have a different size and configuration in order to accommodate the housing of a particular lighting assembly. For example, the first dissipation plate 602 has a greater diameter than the second dissipation plate 604, and the second dissipation plate 604 has a greater diameter than the third dissipation plate 606. While four dissipation plates are illustrated in FIGS. 1 to 5, two of the dissipation plates included in the example embodiment illustrated in FIGS. 1 to 5 are similar to the second dissipation plate 604. However, it is to be appreciated that the dissipation plates are provided for the purpose of illustration and embodiments of the present invention are not limited to these specific shapes and configurations. For example, while the upstanding fins 120 are a certain size, fins of a greater or smaller size may be used depending on the size of the dissipation plates 104 and the size of the housing 102. Also, while the fins 120 are shown being configured at approximately a ninety degree angle, relative to the plane of the dissipation plate 104, other angles may be used. For example, according to one embodiment, the angle of incidence of the fins 120 is approximately 90 degrees. According to another embodiment, the angle of incidence of the fins 120 is within a range of between 30 degrees and 150 degrees. According to another embodiment, the angle of incidence of the fins 120 is within a range of between 60 degrees and 120 degrees. According to another embodiment, the angle of incidence of the fins 120 is within a range of between 85 degrees and 95 degrees. Also, any number of fins, and of any suitable size, may be used. The angle of incidence of fins may also vary on any one of the dissipation plates 104. The angle of incidence of the fins 120 may also vary so that not all have the same angle of incidence.

According to embodiments of the present invention, the lighting apparatus 100 includes at least one dissipation plate. However, a greater number of dissipation plates may be used as the greater number of dissipation plates provides a greater dissipation surface area within the housing 100 that, when combining the surface area of the separate dissipation plates, may results in greater heat transfer. According to one embodiment of the present invention, multiple dissipation plates 104 are positioned a predetermined distance apart from each other in order to permit air flow between and through the dissipation plates 104. The predetermined distance may be any suitable distance that permits and/or increases airflow through and within the housing. According to one embodiment, the dissipation plates 104 are at least approximately three (3) millimeters from each other. According to another embodiment, the dissipation plates 104 are at least approximately one (1) millimeter from each other. The predetermined distance may be also be greater if the size of the housing 102 and/or the size of the dissipation plate 104 is larger. If the dissipation plates 104 are too close together, the air flow between or through the dissipation plates may be reduced.

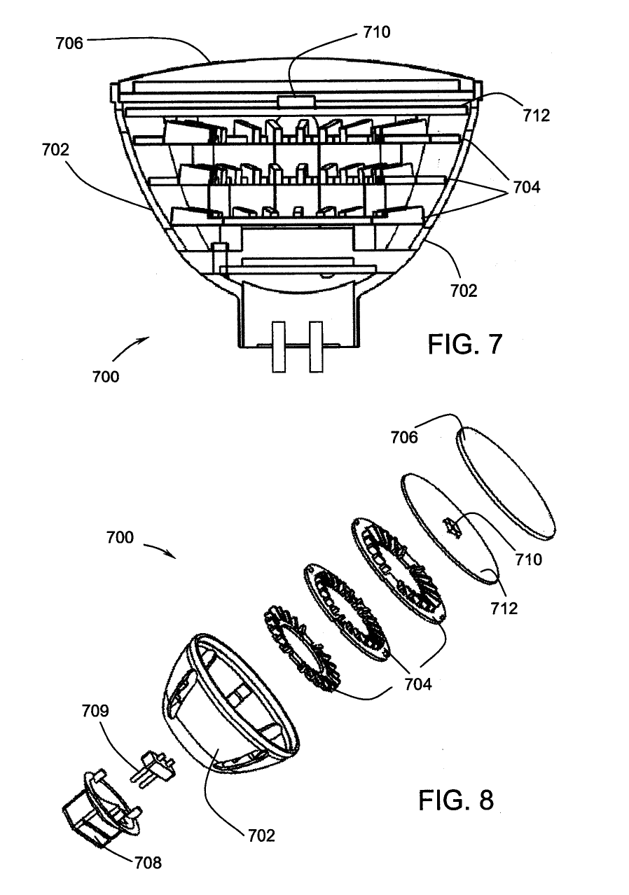

FIG. 7 is a side cross sectional view of a lighting assembly, in accordance with a second embodiment of the present invention. The lighting assembly 700 includes a housing 702, a plurality of dissipation plates 704, a lens 706, a fitting 708, an electrical connector 709, a LED 710, and an LED substrate 712. The housing 702 may include one or more openings 705 defined in the housing 702 to permit the inlet of air into the lighting assembly 700. Each of the dissipation plates 704 (partially shown) includes a plurality of fins 720. Referring now to FIG. 8, an exploded view of the lighting assembly shown in FIG. 7, the order and position of the different components of the lighting assembly 700 can be seen. Unless otherwise specified, the overall configuration and operation of the second embodiment illustrated in FIGS. 7 and 8 is similar to the embodiment illustrated and described with reference to FIGS. 1 to 6. In the second embodiment of the present invention, the positioning of the components is similar to that shown and described with reference to FIGS. 1 to 6, except that the LED 710 and the substrate 712 are positioned proximate to the light emitting end of the housing 702.

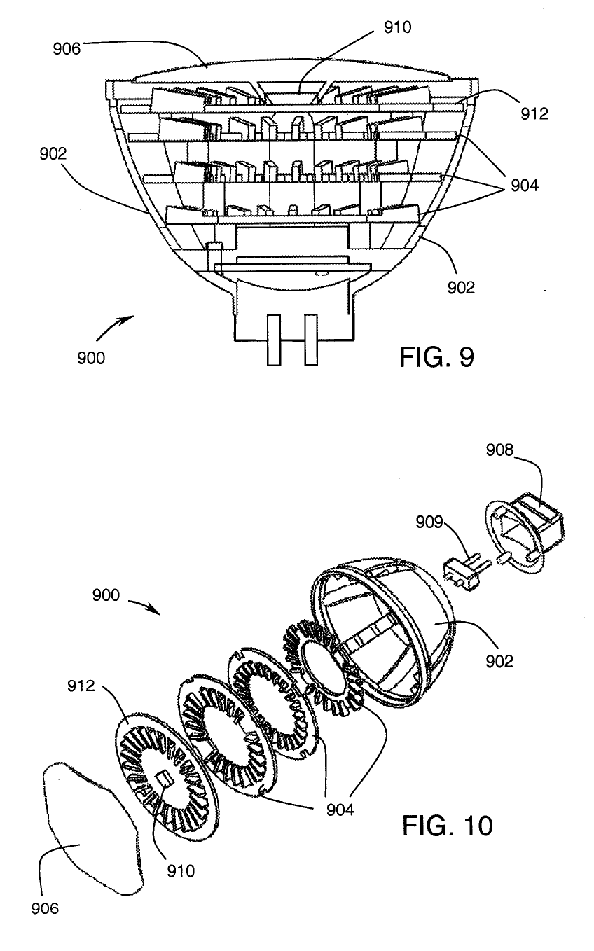

FIG. 9 is a side cross sectional view of a lighting assembly, in accordance with a third embodiment of the present invention. The lighting assembly 900 includes a housing 902, a plurality of dissipation plates 904, a lens 906, a fitting 908, an electrical connector 909, a LED 910, and an LED substrate 912. The housing 902 may include one or more openings 905 defined in the housing 902 to permit the inlet of air into the lighting assembly 900. Each of the dissipation plates 904 (partially shown) includes a plurality of fins 920. Referring now to FIG. 10, an exploded view of the lighting assembly shown in FIG. 9, the order and position of the different components of the lighting assembly 900 can be seen. Unless otherwise specified, the overall configuration and operation of the third embodiment illustrated in FIGS. 9 and 10 is similar to the embodiment illustrated and described with reference to FIGS. 1 to 6. In the third embodiment of the present invention, the positioning of the components is similar to that shown and described with reference to FIGS. 1 to 6, except the LED 910 and the substrate 912 positioned proximate to the light emitting end of the housing 902, and the substrate 912 is also configured to function as one of the plurality of dissipation plates 904. According to one embodiment, the substrate 912 is a metal core printed circuit board (“PCB”) and the substrate is configured to one of the dissipation plates.

One advantage of embodiments of the present invention include low assembly and production cost, the production and assembly requiring only a limited number of components and steps, thereby further reducing the production cost.

While the invention has been particularly shown and described with reference to the illustrated embodiments, those skilled in the art will understand that changes in form and detail may be made without departing from the spirit and scope of the invention. For example, while certain types of materials have been described, other suitable material may also be used. Also, while the specific shape of housings and dissipation plates is illustrated and described, other shapes and configurations may be used without departing from the scope of the present invention. For example, while each of the dissipation plates shown in the illustrated embodiments includes upstanding fins, embodiments of the present invention may also incorporate conventional lighting assembly components as required. Also, while certain optics and lenses are illustrated, other optical modules and components may be used as required by the specific implementation. While certain specific light emitting devices have been described, any type of LED or other light emitting devices may be used. For example, a light emitting device may be bonded directly onto the substrate as chip-on-board package.

Accordingly, the above description is intended to provide example embodiments of the present invention, and the scope of the present invention is not to be limited by the specific examples provided.

What is claimed is:

1. A heat exchange apparatus comprising:
one or more dissipation plates, each of the one or more dissipation plates having a plurality of upstanding fins disposed from the dissipation plate at a predetermined angle, and wherein each of the one or more dissipation plates defines a plurality of slots configured to permit airflow longitudinally through the housing; and
a housing configured to receive the one or more dissipation plates, the housing defining at least one opening to permit an inlet of air into the housing.

2. The heat exchange apparatus of claim 1, further comprising one or more substrates, and one or more light emitting devices on the one or more substrates, and wherein the one or more substrates provides an electrical connection for receiving power and transmitting power to the one or more light emitting devices.

3. The heat exchange apparatus of claim 2, wherein the substrate and the light emitting device are behind the one or more dissipation plates.

4. The heat exchange apparatus of claim 2, wherein the substrate and the light emitting device are in front of the one or more dissipation plates.

5. The heat exchange apparatus of claim 3, wherein the substrate is a metal core PCB and the substrate is configured as a dissipation plate.

6. The heat exchange apparatus of claim 2, wherein the light emitting device is bonded directly onto the substrate as chip-on-board package

7. The heat exchange apparatus of claim 1, wherein the predetermined angle is approximately 90 degrees.

8. The heat exchange apparatus of claim 1, wherein the predetermined angle is in a range between approximately 60 degrees and approximately 85 degrees.

9. The heat exchange apparatus of claim 1, wherein the one or more dissipation plates are parallel and spaced a predetermined distance apart from each other, wherein the predetermined distance permits airflow between at least two of the one or more dissipation plates.

10. Alighting assembly comprising:
a housing having at least one opening to permit the inlet of air into the housing;
one or more dissipation plates positioned within the housing, each of the plurality of dissipation plates having a plurality of fins disposed from each of the plurality of dissipation plates at a predetermined angle, one or more dissipation plates axially aligned within the housing;
a substrate positioned within the housing; and
one or more light emitting device bonded on the substrate, wherein the substrate provides an electrical connection for receiving power and transmitting power to the one or more light emitting devices.

11. The lighting assembly of claim 10, wherein the light emitting device includes one or more light emitting diodes (LED).

12. The lighting assembly of claim 10, wherein the substrate is a metal core PCB and the substrate is configured as a dissipation plate.

13. The lighting assembly of claim 10, wherein the light emitting device is bonded directly onto the substrate as chip-on-board package

14. The lighting assembly of claim 10, wherein the predetermined angle is approximately 90 degrees.

15. The lighting assembly of claim 10, wherein the predetermined angle is in a range between approximately 60 degrees and approximately 120 degrees.

16. The lighting assembly of claim 10, wherein each of the one or more dissipation plates defines a plurality of slots, wherein the plurality of slots is configured to permit air flow past the one or more dissipation plates.

17. The lighting assembly of claim 10, wherein the one or more dissipation plates are parallel and spaced a predetermined distance apart from each other, wherein the predetermined distance permits airflow between two of the one or more dissipation plates.

18. The lighting assembly of claim 10, wherein the housing further includes a plurality of supports configured to receive and position the one or more dissipation plates at the predetermined distance apart from each other.

19. Alighting assembly comprising:
a housing having at least one opening to permit the inlet of air into the housing;
light emitting means for generating light, the light emitting means positioned within the housing;
dissipation means for dissipating heat caused by the light emitting means during operation of the lighting assembly, the dissipation means positioned within the housing, the dissipation means includes a first plurality of surfaces lying in a lateral plane and a second plurality of surface lying in one or more longitudinal planes, and where the dissipation means defines openings for the passage of air within the housing in both the lateral and the longitudinal directions; and
connection means for providing current to the light emitting means.

20. The lighting assembly of claim 19, wherein dissipation means includes a plurality of dissipation plates, each of the plurality of dissipation plates having at least one surface in the lateral plane and a plurality of fins lying in the one or more longitudinal planes.
